(19) United States
(12) Patent Application Publication
(10) Pub. No.: US 2023/0407117 A1
(43) Pub. Date: Dec. 21, 2023

(54) BIOFUNCTIONAL INK FOR RECONSTRUCTION OF RIGID LIVING SYSTEMS

(71) Applicant: KING ABDULLAH UNIVERSITY OF SCIENCE AND TECHNOLOGY, Thuwal (SA)

(72) Inventors: Alan AVILA-RAMIREZ, Thuwal (SA); Panagiotis BILALIS, Thuwal (SA); Charlotte A.E. HAUSER, Thuwal (SA); Alexander VALLE-PEREZ, Thuwal (SA)

(21) Appl. No.: 18/210,173

(22) Filed: Jun. 15, 2023

Related U.S. Application Data
(60) Provisional application No. 63/353,906, filed on Jun. 21, 2022.

(51) Int. Cl. C09D 11/101; C09D 11/04; C09D 11/107; C09D 11/03; B33Y 70/10

(52) U.S. Cl. CPC C09D 11/101; C09D 11/04; B33Y 70/10; C09D 11/03; C09D 11/107

(57) ABSTRACT

Described is a biomaterial/carbonate-based ink that comprises a biopolymer-based mixture and bioceramics. The photo- and ionic crosslinkable biopolymer mixture comprises polysaccharide and gelatin-based materials. The bioceramics comprises an apatite and a carbonate. The biopolymer-based mixture is mixed with the bioceramics to form the ink. The ink is capable of being applied under wet or dry conditions. The wet condition is seawater or water or other aqueous solution. The ink is capable to instantly get solidified, when UV or blue light is applied in the presence of the ionic components found in seawater. After photo- or ionic crosslinking, this ink is stable for months.

### CROSS-REFERENCE TO RELATED APPLICATIONS

This application claims benefit of priority of U.S. Provisional Patent Application No. 63/353,906, entitled, “NATURAL-BASED INK FOR BIORECONSTRUCTION OF LIVING SYSTEMS,” filed Jun. 21, 2022, and makes reference to “ECOLOGICALLY FRIENDLY BIOFUNCTIONAL INK FOR RECONSTRUCTION OF RIGID LIVING SYSTEMS UNDER WET CONDITIONS,” in International Journal of Bioprinting journal published on Aug. 19, 2021. The entire content and disclosure of this patent application and publication is incorporated herein by reference in their entirety.

This application makes reference to U.S. Provisional Application No. 63/353,937, entitled “PRINTABLE CALCIUM CARBONATE PASTE FOR SURGICAL AND ENVIRONMENTAL APPLICATIONS,” filed Jun. 21, 2022, and to “SUSTAINABLE AND ECO-FRIENDLY CORAL RESTORATION THROUGH 3D PRINTING AND FABRICATION,” in ACS Sustainable Chemistry & Engineering journal published on Sep. 2, 2021. The entire contents and disclosures of this patent application and publication is incorporated herein by reference in its entirety.

### BACKGROUND

### Field of the Invention

The present disclosure relates generally to biofunctionalized inks and, particularly, to ecologically friendly biofunctionalized inks for the reconstruction of rigid living systems under wet or dry conditions.

### Background of the Invention

The development of 3D-printable inks plays an important role for several applications, from industrial manufacturing to novel applications for biomedical engineering. Currently, very few studies report the use of ecologically friendly inks for reconstruction of rigid living systems under wet conditions, since most conventional approaches require the use of synthetic polymers. Therefore, there is an unmet need to develop ecologically friendly biofunctional inks.

### SUMMARY

According to first broad aspect, the present disclosure provides a carbonate-based ink comprising a biopolymer-based mixture and a bioceramics. The biopolymer-based mixture comprises a gelatin and a polysaccharide. The bioceramicss comprises an apatite. The biopolymer-based mixture is mixed with the bioceramics to form the ink. The ink is capable of being applied under wet or dry condition.

According to a second broad aspect, the present disclosure provides a carbonate-based ink comprising a high gelatin methacrylate, a gelatin, a photoinitiator, a polysaccharide, a polyether, an apatite, a carbonate, and a solvent. The high gelatin methacrylate, the gelatin, the photoinitiator, the polysaccharide, and the polyether are dissolved in the solvent to form a first mixture. The apatite and the carbonate are mixed with the first mixture to form the ink. The ink is capable of being applied under wet or dry condition.

According to a third broad aspect, the present disclosure provides a method of manufacturing a carbonate-based ink comprises mixing a bioceramics with a biopolymer-based mixture to form the carbonate-based ink. The bioceramics comprises an apatite and a carbonate. The biopolymer-based mixture comprises a solvent, a high gelatin methacrylate, a gelatin, a photoinitiator, a polysaccharide, and a polyether. The ink is applied under wet or dry condition.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

The patent or application file contains at least one drawing executed in color. Copies of this patent or patent application publication with color drawing(s) will be provided by the office upon request and payment of the necessary fee.

FIGS. 1A-IC illustrate exemplary examples from the disclosed project scope according to one embodiment of the present disclosure.

FIGS. 2A-2E illustrate 2D/3D fabrication structures according to one embodiment of the present disclosure.

FIGS. 3A-3B illustrate morphological studies of a 3D dried printed grid according to one embodiment of the present disclosure.

FIGS. 4A-4C illustrate FT-IR spectra, XRD-P spectra, and ¹³C MAS NMR spectra according to one embodiment of the present disclosure.

FIGS. 5A-5B illustrate thermal analysis of bioceramics according to one embodiment of the present disclosure.

FIGS. 6A-6C illustrate rheological characterization of non-crosslinked ink according to one embodiment of the present disclosure.

FIGS. 7A-7G illustrate biological assessments according to one embodiment of the present disclosure.

FIGS. 8A-8F illustrate H-GelMA synthesis according to one embodiment of the present disclosure.

FIGS. 9A-9B illustrate methodology of image processing to assess the printing fidelity of a sample according to one embodiment of the present disclosure.

FIG. 10 illustrates data obtained from the image processing analysis according to one embodiment of the present disclosure.

FIG. 11 illustrates 3D response surface plot representing the effect of adding hydroxyapatite and calcium carbonate to a developed ink over the structural definition of a printed structure according to one embodiment of the present disclosure.

FIG. 12 illustrates XRD diagrams from sole hydroxyapatite and calcium carbonate as the source of the bioceramics reinforcement from the ink formulation according to one embodiment of the present disclosure.

FIGS. 13A-13B illustrate NMR spectrum of a biopolymer-base according to one embodiment of the present disclosure.

FIG. 14 illustrates a graphical-artistical abstract for explanation of the disclosed project according to one embodiment of the present disclosure.

FIG. 15 illustrates a dropper/closure device for delivering a carbonate-based ink according to one embodiment of the present disclosure.

FIG. 16 illustrates a squeeze bottle device for delivering a carbonate-based ink according to one embodiment of the present disclosure.

FIG. 17 illustrates an injectable device for delivering a carbonate-based ink according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

Unless defined otherwise, all technical and scientific terms used herein have the same meaning as is commonly understood to which the claimed subject matter belongs. In the event that there is a plurality of definitions for terms herein, those in this section prevail. All patents, patent applications, publications and published nucleotide and amino acid sequences (e.g., sequences available in GenBank or other databases) referred to herein are incorporated by reference. Where reference is made to a URL or other such identifier or address, it is understood that such identifiers can change and particular information on the internet can come and go, but equivalent information can be found by searching the internet. Reference thereto evidences the availability and public dissemination of such information.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present disclosure, the term “comprising,” the term “having,” the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present disclosure, the term “amino acid” refers to the molecules composed of terminal amine and carboxylic acid functional groups with a carbon atom between the terminal amine and carboxylic acid functional groups sometimes containing a side chain functional group attached to the carbon atom (e.g., a methoxy functional group, which forms the amino acid serine). Typically, amino acids are classified as natural and non-natural. Examples of natural amino acids include glycine, alanine, valine, leucine, isoleucine, proline, phenylananine, tyrosine, tryptophan, serine, threonine, cysteine, methionine, asparagine, glutamine, lysine, arginine, histidine, aspartate, and glutamate, among others. Examples of non-natural amino acids include L-3,4-dihydroxyphenylalanine, 2-aminobutyric acid, dehydralanine, g-carboxyglutamic acid, camitine, gamma-aminobutyric acid, hydroxyproline, and selenomethionine, among others. In the context of this specification, it should be appreciated that the amino acids may be the L-optical isomer or the D-optical isomer.

For purpose of the present disclosure, the term “apatite” refers to a group of phosphate minerals. It includes hydroxyapatite, fluorapatite, and chlorapatite.

For purposes of the present disclosure, the term “biopolymer-based mixture” refers to a mixture that includes biopolymer. Biopolymers include natural polymers produced by the cells of living organisms.

For purposes of the present disclosure, the term “bioceramic” refers to a ceramic material that is biocompatible.

For purposes of the present disclosure, the term “carbonate-based ink” refers to a type of ink that utilizes carbonate.

For purposes of the present disclosure, the term “effective amount” or “effective dose” or grammatical variations thereof refers to an amount of an agent sufficient to produce one or more desired effects. The effective amount may be determined by a person skilled in the art using the guidance provided herein.

For purposes of the present disclosure, the term “enhance” and the term “enhancing” refer to increasing or prolonging either in potency or duration of a desired effect.

For purposes of the present disclosure, the term “extrusion-based 3D printing” refers to Fused Deposition Modeling (FDM). It is a 3D printing process that uses spools of plastic or metal filament that extrudes through a temperature-controlled nozzle layer by layer to create a 3D part.

For purposes of the present disclosure, the term “hydroxyapatite” refers to naturally occurring mineral form of calcium apatite. Hydroxyapatite is the hydroxyl end member of the complex apatite group. The OH⁻ ion can be replaced by fluoride, chloride, or carbonate.

For purposes of the present disclosure, the term “light,” unless specified otherwise, refers to any type of electromagnetic radiation. Although, in the embodiments described below, the light that is incident on the gratings or sensors is visible light, the light that is incident on the gratings or sensors of the present disclosure may be any type of electromagnetic radiation, including infrared light, ultraviolet light, etc., that may be scattered by a grating or sensor. Although, in the embodiments described below, the light that is scattered from the gratings or sensors and detected by a detector is visible light, the light that is scattered by a grating or sensor of the present disclosure and detected by a detector of the present disclosure may be any type of electromagnetic radiation, including infrared light, ultraviolet light, etc. that may be scattered by a grating or sensor.

For purposes of the present disclosure, the term “photoinitiator” refers to a molecule that creates reactive species such as free radicals, cations or anions when exposed to radiation such as UV or visible sources such as blue light, for example.

For purposes of the present disclosure, the term “polyether” refers to any of a class of organic substances prepared by joining together or polymerizing many molecules of simpler compounds such as monomers by establishing ether links between them, which may be either chainlike or network like in molecular structure.

For purposes of the present disclosure, the term “polysaccharide” refers to long chains of carbohydrate molecules, composed of several smaller monosaccharides. Polysaccharide includes homopolysaccharide or a heteropolysaccharide depending upon the type of the monosaccharides. Polysaccharides can be a straight chain of monosaccharides such as linear polysaccharides, or it can be branched such as branched polysaccharides.

For purposes of the present disclosure, the term “room temperature” refers to a temperature of from about 20° C. to about 25° C.

For purposes of the present disclosure, the term “solvent” refers to a substance that dissolves a solute, resulting in a solution.

For purposes of the present disclosure, the term “3D printing” refers to the action or process of making a physical object from a three-dimensional digital model which may typically include laying down many thin layers of a material in succession. In some embodiments, 3D printing, or additive manufacturing is the construction of a three-dimensional object such as from a CAD model or a digital 3D model that is converted into a G-code that provides the pathway to define the printed structure. It can be done in a variety of processes in which material is deposited, joined, or solidified under computer control, with the material being superposed layer-by-layer and added together (such as termo-plastics, viscous-liquids or compressed-powder grains being fused), typically layer by layer.

### DESCRIPTION

While the invention is susceptible to various modifications and alternative forms, a specific embodiment thereof has been shown by way of example in the drawings and will be described in detail below. It should be understood, however, that it is not intended to limit the invention to the particular forms disclosed, but on the contrary, the invention is to cover all modifications, equivalents, and alternatives falling within the spirit and the scope of the invention.

The development of 3D-printable inks plays an important role in several applications, from industrial manufacturing to novel applications for biomedical engineering. Remarkably, biomaterials for tissue engineering applications can be expanded to other new horizons; for instance, restoration of rigid living systems such as coral reefs is an emergent need derived from recent issues from climate change. The coral reefs have been endangered, which can be observed in the increasing bleaching around the world. Very few studies report eco-friendly inks for matter since most conventional approaches require synthetic polymer, which at some point could be a pollutant depending on the material. Therefore, there is an unmet need for cost-effective formulations from eco-friendly materials for 3D manufacturing to develop carbonate-based inks for coral reef restoration. Disclosed embodiments derive from technologies developed for regenerative medicine, commonly applied for human tissues like bone and cartilage. In the disclosed application, disclosed embodiments create a novel biomaterial formulation from biopolymers such as GelMA, PEGDA, alginate, and gelatin as scaffold and binder for the calcium carbonate and hydroxyapatite bioceramics needed to mimic the structure of rigid structures. The present disclosure presents evidence from 2D/3D manufacturing, chemical, mechanical, and biological characterization, which supports the hypothesis of its utility to aid in the fight to counteract the coral bleaching that affects the marine ecosystem, primarily when there is supported by solid research in biomaterials science used for living systems. It can extend tissue engineering into new approaches in different domains such as environmental or marine sciences.

Biomaterials have been essential elements in developing technologies that counteract the current issues in the biomedical field[1]. On the other hand, there is a strong interest from the industry to create new technologies based on eco-friendly biopolymers that can be cost-effective for the current needs in the market[2]. Therefore, several studies coming from the development of biomaterials are a trending topic for medical applications. Researchers commonly look for natural sources that could potentially be chemically and physically modified to surpass their ground state behavior[3]. A couple of examples are gelatin and alginate as one of the classic materials for tissue regeneration. Gelatin comes from inexpensive natural sources; on the other side, alginate has ionic-crosslinking behavior that permits crosslinking with cations like calcium. Both biopolymers are used for cartilage replacements, bone regeneration, drug delivery, and even exciting uses for molecular gastronomy. Gelatin usually works as a viscous platform to bind other elements of interest.

Nevertheless, to expand the functionality of these materials in tissue engineering, it has been studied the methacrylation reaction; in this case, the functionalization of gelatin can be photo-crosslinked by different wavelengths, depending on the photoinitiator used. This physicochemical improvement has permitted the usage of novel biofrabrication techniques[4]. Besides applications in wound dressings and hard tissues, cartilages or bones have been implemented with gelatin methacrylate (GelMA), with reinforcements with bioceramics as hydroxyapatite and other sort inorganic particles[5, 6]. Additionally, poly (ethylene glycol diacrylate) (PEGDA) has been widely implemented due to its fast end effective crosslinking behavior, which can work as a complement to other photo-cross-linkable polymers[7].

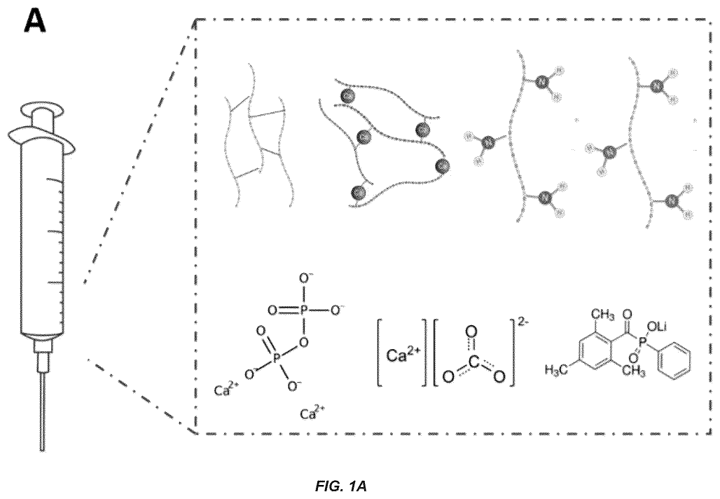

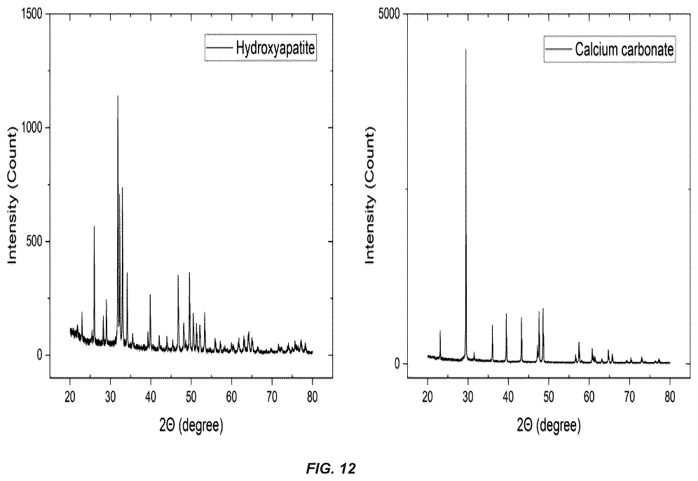

Innovation should not be stuck in just a particular direction; conversely, there are other biological issues that our world is currently facing. Therefore, eco-friendly applications that could counteract problems derived from climate change are crucial to take action soon. Thus, disclosed embodiments aim to expand tissue engineering applications into a broader range of goals in the disclosed project. For instance, one of the most significant burdens from the environmental and marine sciences is coral bleaching, in other words, can be considered the disruption of a symbiosis that consists of a robust and rigid system of calcium carbonate with the living beings, which are mainly species of polyps derived from heatwave and changes in the marine ecosystem that bleaches the colonies and have strong effects in the marine biota[8, 9]. For this reason, creating and developing new formulations and taking advantage of new innovative materials is crucial for counteracting environmental problems as groups around the world have been started to be interested in, as a way of preventing more extensive problems that will jeopardize the lives of human beings in the future[10, 11]. Therefore, in disclosed embodiments, biopolymers such as gelatin, alginate, gelatin methacrylate (GelMA), and poly (ethylene glycol diacrylate) (PEGDA) are reinforced with bioceramics as calcium carbonate and hydroxyapatite. This unique formulation can assist the growth of rigid-living systems, which can also be understood as highly structured bone-like self-organizing life forms, that interact with a biological environment like musculoskeletal tissues or corals, as an innovative technology that ionic/photo-crosslink, which makes it adaptable to new 3D manufacturing technologies and can withstand under wet conditions (FIGS. 1A-1C and 14). FIG. 1A illustrates the integration of biopolymers gelatin, alginate, GelMA, PEGDA, and bioceramics calcium carbonate and hydroxyapatite for potential rigid-living systems. FIG. 1B illustrates schematics from the two primary sources of crosslinking to enhance printability, ionic-crosslinking with cations like calcium and photo-crosslinking with a wavelength range from 365 nm to 405 nm. FIG. 1C illustrates the proposal for a potential future application with this material for rigid-living systems can be manufactured with extrusion-based 3D printing technologies.

In one embodiment, disclosed embodiments provide a carbonate-based ink comprising a biopolymer-based mixture and a bioceramics. The biopolymer-based mixture may comprise a gelatin and a polysaccharide. The bioceramics may comprise an apatite. The biopolymer-based mixture may be mixed with the bioceramics to form the ink. The ink is capable of being applied under wet or dry conditions. The wet condition may include seawater or water or other aqueous solution.

In one embodiment, a biopolymer-based mixture further comprises a high gelatin methacrylate, a photoinitiator, and a polyether and wherein the bioceramics further comprises a carbonate

In one embodiment, a carbonate-based ink comprising a high gelatin methacrylate, a gelatin, a photoinitiator, a polysaccharide, a polyether, an apatite, a carbonate, and a solvent. The high gelatin methacrylate, the gelatin, the photoinitiator, the polysaccharide, and the polyether are dissolved in the solvent to form a first mixture. The apatite and the carbonate are mixed with the first mixture to form the ink. The ink is capable of being applied under wet or dry conditions. The wet condition may include seawater or water or other aqueous solution.

In one embodiment, a photoinitiator is a lithium phenyl-2,4,6, trimethylbenzoylphosphinate (LAP).

In one embodiment, an apatite is a hydroxyapatite.

In one embodiment, a polysaccharide is an alginic acid.

In one embodiment, a polyether is a poly (ethylene glycol diacrylate).

In one embodiment, a solvent is at least one selected from the group consisting of dimethyl sulfoxide (DMSO), phosphate-buffered saline (PBS), and seawater or water or other aqueous solution.

In one embodiment, a carbonate is a calcium carbonate.

In one embodiment, disclosed embodiments provide a method of manufacturing a carbonate-based ink comprises mixing a bioceramics with a biopolymer-based mixture to form the carbonate-based ink. The bioceramics may comprise an apatite and a carbonate. The biopolymer-based mixture may comprise a solvent, a high gelatin methacrylate, a gelatin, a photoinitiator, a polysaccharide, and a polyether. The ink is applied under wet or dry conditions. The wet condition may include seawater or water or other aqueous solution.

In one embodiment, disclosed embodiments provide a method of making a biopolymer-based mixture comprises mixing a high gelatin metacrylate, a gelatin, a polysaccharide, and a polyether in a solvent at an average temperature in a range, for example, of approximately 20 to 50° C. to form a first mixture and adding a photoinitiator to the first mixture while avoiding an interaction with UV light or visible light to produce the biopolymer-based mixture.

In one embodiment, a solvent is water.

In one embodiment, a method of applying carbonate-based ink comprises 2D-3D printing or 2D-3D molding with carbonate-based ink.

In one embodiment, disclosed embodiments provide a kit comprises an effective amount of a carbonate-based ink. The carbonate-based ink may be applied in at least one selected from the group consisting of 2D-3D printing and 2D-3D molding.

In one embodiment, disclosed embodiments provide a device for applying a carbonate-based ink comprises an effective amount of the carbonate-based ink. The carbonate-based ink may be applied in at least one selected from the group consisting of 2D-3D printing and 2D-3D molding.

In one embodiment, a 3D printing is an extrusion-based 3D printing.

In one embodiment, a device is selected from the group consisting of a container with a dropper/closure device, a squeeze bottle device, and an injectable device.

### Results and Discussion

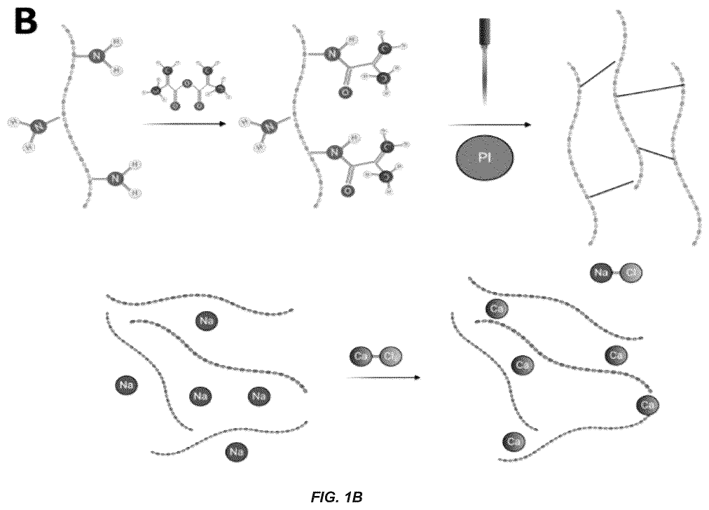

The ink is printed in an extrusion-based 3D printing at a pre-crosslinked state with the aid of the robotic arm system. In this example, several layers can be printed one over another without collapsing. Moreover, with the aid of blue light, crosslinking can aid in printing invent more complex structures. For this case, disclosed embodiments demonstrated that it could be done even at the ground state behavior from the formulation. For instance, with the incidence of blue light, the printed structure can be easier to manufacture and more stable in the air or under wet conditions. An underwater printing test was done; a 2D structure of a grid and another at undersea water of the KAUST (FIG. 2C) name was printed and kept after twelve weeks in seawater, without visible degradation, derived from the photo-crosslinking of PEGDA and GelMA and ionic-crosslinking of alginate with calcium ions found in the filtered water obtained from the Red sea, permitting the appliance of this material directly in damaged coral reefs.

Additionally, as printing takes significant amounts of time, disclosed embodiments established a 3D molding protocol. The ink was directly poured into the negative molds obtained from natural coral structures; these samples were dried at room temperature overnight. These structures coming from the mold were rigid and complex; consequently, this is a cost-effective methodology that doesn't require robust equipment.

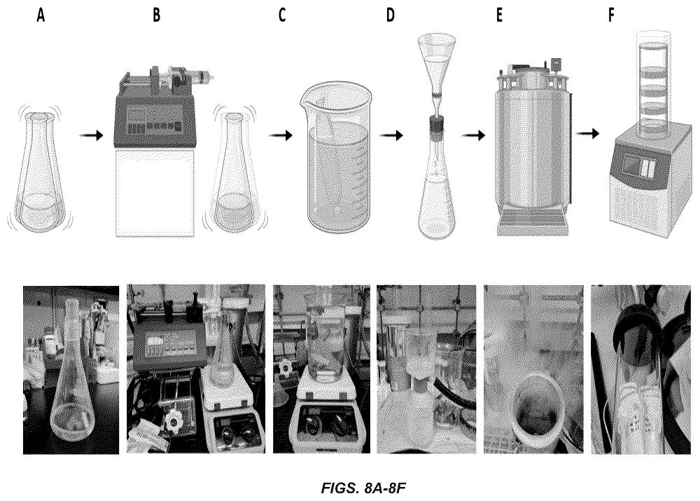

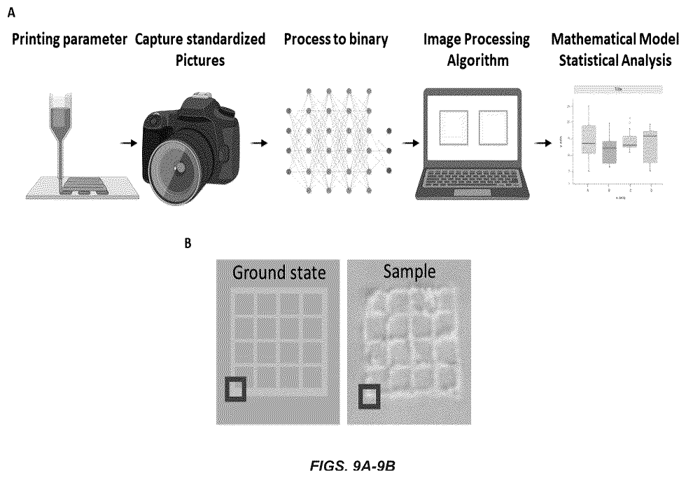

During the formulation development, in accordance with disclosed embodiments, the ink was enhanced by adding hydroxyapatite (to improve the under-water stability property) and calcium carbonate (to increase the stiffness from the printed or molded objects). It was observed that the integration of these two components to the original ink composition affected the overall structural definition of the printed objects (FIGS. 2A-2E). FIGS. 2A-2A″ illustrate 3D printing of a 50-layer cylindric structure with the aid of an assembled 6-degree-of-freedom robotic arm system coupled with an extrusion-based bioprinter. FIG. 2B illustrates the image processing technique to obtain a structural similarity index measurement (SSIM). FIGS. 2C-C″ illustrate manufacturing under wet conditions of structure KAUST one-layer structure and a squared-grid. FIG. 2D illustrates molded structures dried at room temperature overnight. FIG. 2E illustrates squared grid printed and details at millimetric scale after crosslinking and desiccation. The contour plot representation of the surface response graph can be found as part of the supplementary material (FIGS. 10-11). FIG. 10 illustrates data obtained from the image processing analysis to find the best ratio of bioceramics that are imbued in the biopolymer-base. Also, an example of how the MATLAB code is working, where two images are compared, and disclosed embodiments get a convergence of both pictures, gives us a mathematical value to process in a statistical model (FIG. 10). The model presented an adjustment >98% and contour plot representation of the effect in adding hydroxyapatite and calcium carbonate to the developed ink over the structural definition of the printed structure (FIG. 11). The original ink exhibited a structural definition between 0.92 to 0.94; however, it was found that the definition could be improved (SSIM >0.95) by the addition of 0.1 g/cm³ to 0.6 g/cm³ of hydroxyapatite (FIG. 2). On the other hand, the addition of calcium carbonate resulted in a lower structural definition (SSI <0.92). Nevertheless, it was found that when adding both: calcium carbonate and hydroxyapatite, the structural definition from the printed object could be preserved (SSIM >0.92), even with the presence of the calcium carbonate in ink, possible when simultaneously adding 0.1 g/cm³ to 0.2 g g/cm³ of calcium carbonate and 0.1 g/cm³ to 0.6 g g/cm³ of hydroxyapatite (FIG. 2). Similarly, the addition of 0.8 g/cm³ g of calcium carbonate and 0.2 g/cm³ to 0.6 g/cm³ of hydroxyapatite resulted in a high structure definition. It is essential to highlight that adding beyond 0.7 g/cm³ of hydroxyapatite in the presence of calcium carbonate reduces the structure definition (SSI <0.875) of the printed object (FIGS. 10-11). Therefore, the development of enhanced inks for under seawater printing without losing their printing definition can be carried by adding these two components to the original ink according to the previously described maximization conditions.

It is important to clarify that due to the loss of solvent derived from room temperature desiccation, the structure slighted gets deformed. For this reason, a fast image processing test was done, arrowing 97.5% similarity between a 3D printed cylinder of 50 layers after crosslinking and desiccation (FIG. 2B). This analysis is an innovative way to characterize printing fidelity; nevertheless, more improvements in the technique could be made in further studies to get more accurate results.

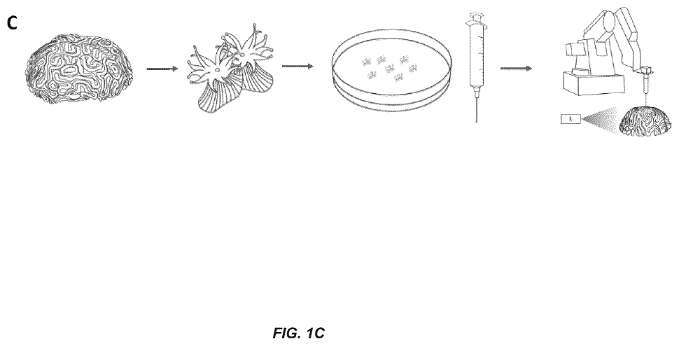

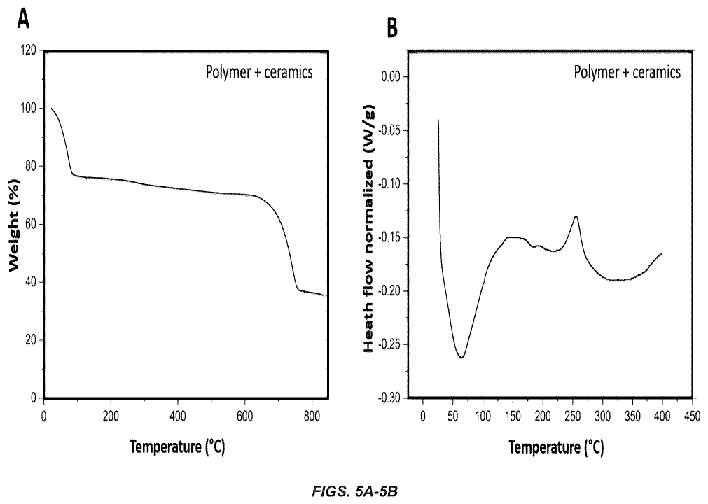

This ink was designed to be helpful as a carrier for biological cargo in different orders of magnitude, depending on the biological species of interest that could go from 50 micrometers (corroborated at FIGS. 7A-7G) until the printing resolution of the assembled 3D printing system that experimentally was 1 mm (FIGS. 3A-3B). FIG. 7A illustrates growth of mesenchymal stem cells cultured in direct contact with the developed ink for 1 day. FIG. 7B illustrates growth of mesenchymal stem cells cultured in direct contact with the developed ink for 4 days. FIG. 7C illustrates growth of mesenchymal stem cells cultured in direct contact with the developed ink for 7 days. The cells were also cultured in 2D for the same amount of time as a control (FIGS. 7D-7F) Amount of metabolically active mesenchymal stem cells during 1, 4, and 7 days. (FIG. 7G). These cells were cultured with the ink (treatment) and with growth media (control). The assay was quantified in terms of relative fluorescence units (RFU) (FIG. 7G).

FIG. 3A illustrates demonstration of the feasibility of printing at a resolution of approximately 1 mm with the aid of a commercial extrusion-based bioprinter. FIG. 3B illustrates SEM of the same grid at the microscale at different sizes, to see the morphology of the surface and the binding from the bioceramics crystals to the polymer. In the scanning electron microscope pictures (FIG. 3B), the binding from the polymer can be an attachment from the calcium carbonate and hydroxyapatite round crystals; GelMA and gelatin offer the porous platform to get the crystals incrusted due to its long polymer chains at a molecular level[19-21].

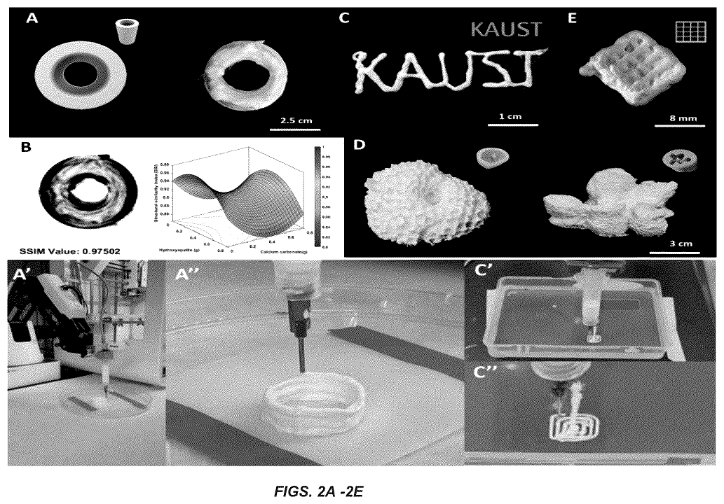

FIG. 4A illustrates FT-IR spectra from the formulation under different crosslinking conditions, initially in room temperature conditions, with the incidence of blue-light at 405 nm and ionic-crosslinking with calcium chloride at 6% solution. FIG. 4B illustrates XRD-P spectra from ink formulation of the biopolymers and bioceramics. FIG. 4C illustrates ¹³C MAS NMR spectra of biopolymers without (above) and with (below) bioceramics. FT-IR corroborated the two crosslinking behaviors from the ink (FIG. 4A); one clear result from the ionic-crosslinking comes from the OH peak observed at 3300 cm⁻¹, that states the covalent bonding between hydroxyl groups in Alginic acid polysaccharides. The photo-crosslinked material and the exposure at room conditions are similar due to the photoinitiation with a wavelength in the spectrum related to blue light that can come from regular exposure to light; therefore, crosslinking occurs at a lower rate. Evidence from these is the peaks from N—H and C—H at 2950 cm⁻ and 2990 cm⁻¹. Finally, carbonate and phosphate ions appear in the 1400 cm⁻¹ and 1000 cm⁻¹ peaks, referring to bioceramics in the sample.

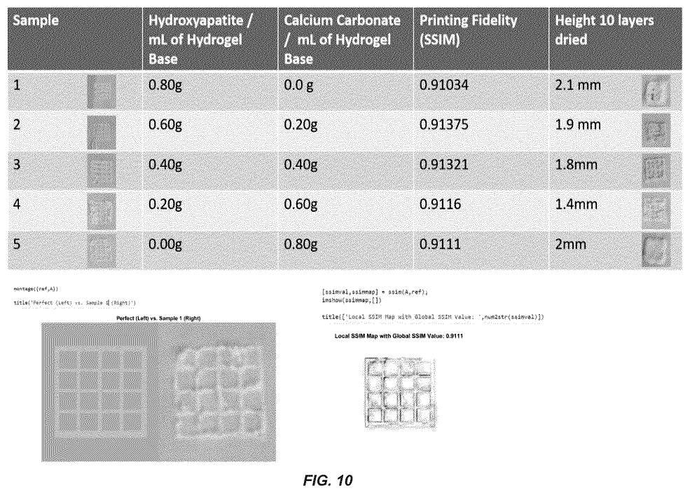

The peaks from XRD (FIG. 4B) represent the mixture of bioceramics components from the ink. This study helped us understand ceramics' chemical interaction with the natural base polymer to corroborate its crosslinking behavior and binding with the polymer base[22, 23]. Therefore, in the final formulation analysis, both calcium carbonate and hydroxyapatite peaks remained unaltered compared to the crystals from both bioceramics components, stating no crystal rearrangement or direct modification contact with the polymer source. Besides, the calcium carbonate peaks at 23°, 29°, 36°, 39°, 43°, 47°, 48°, and 580 correspond to a crystal structure reported in the literature as calcite, remarkably seen at the strong peak from 290 [24]. On the other side, hydroxyapatite's most representative signals appear at 26°, 32°, 39°, and 490 highlighting the intensity of the ones in between 30 and 35 that usually appears stronger in literature, and both of them can be observed in the supplementary measurements (FIG. 12) where XRD was done just to each independent bioceramics[25].

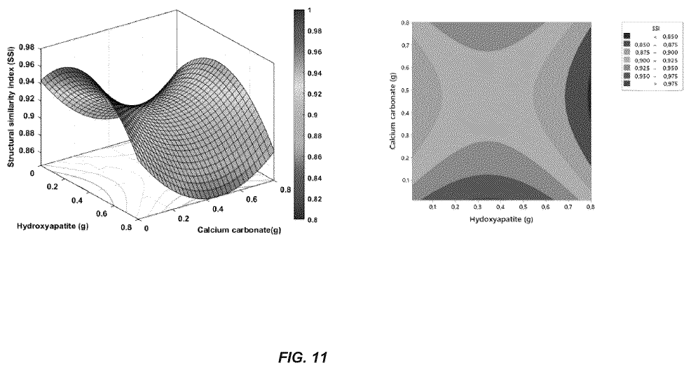

The biopolymer structure was investigated using ¹³C solid-state NMR spectroscopy. The differences between ¹³C MAS NMR spectra (FIG. 4C) of the sample without and with bioceramics can be distinguished. The most significant result is the double peak (blue box) appears between 155 and 135 ppm, which correspond to C═CH that result of the interaction of a C group from the polymer attached to carbonate ions from the sample[26], the rise in the orange box, at 50 ppm, and the green box, between 35 and 25 ppm, disappears when there are bioceramics; therefore, these signals are a piece of evidence from the interaction of binding from inorganic components of calcium, phosphate, and carbonate ions to the biopolymer side from the formulation, this data can be corroborated in future studies with ³¹P MAS NMR and ⁴³Ca MAS NMR. [27, 28]. FIG. 13A illustrates ¹H NMR (solution-state) spectrum of biopolymer-base. FIG. 13B illustrates ¹³C NMR (solution-state) spectrum of biopolymer-base.

Besides, in ¹H-NMR (FIG. 13A), it can be complemented the presence of the methacrylation functionalization of the GelMA synthesis and PEGDA integration as the methacrylate ions can be observed between 6 and 6.5 ppm[28, 29].

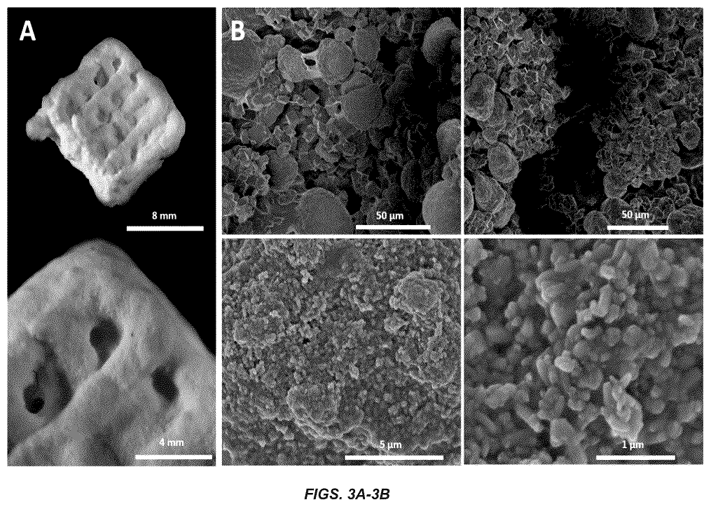

TGA (FIG. 5A) and DSC thermograms of bioceramics (FIG. 5B) incorporated in the biopolymer base. In the thermogravimetric analysis (FIG. 5A), there is a reduction of 13% of weight from 90° C.-100° C. due to the loss of H₂O-coordinated ions remaining in the crystalline arrangements of ceramics compressed with the polymer. From 100° C. to 642° C., there is a loss of 10% from the sample, equivalent to the biopolymers that were calcined under this procedure; this variation comes from the different polymeric ionic/photo-crosslinking behaviors of the components. The final loss from the 39% of the material comes from the calcium carbonate in the sample; the rest comes from some residues from hydroxyapatite, which is the strongest component to decompose by heat in this formulation[23]. In the differential scanning calorimetry (FIG. 5B), as several distinct chemical behaviors are coming from different sources of crosslinking and the inorganic composition, therefore, the initial broad peak corroborates the TGA statement of dehydration; also, it can be stated that a glass transition (Tg) can be observed in the shoulder at 175° C., a slight crystallization point (Tc) can be observed at the exothermic downslide at 225° C., and finally a melting point (Tm), presumably all organic compounds coming from biopolymers, can be detected at 260° C. in the endothermic peak[30].

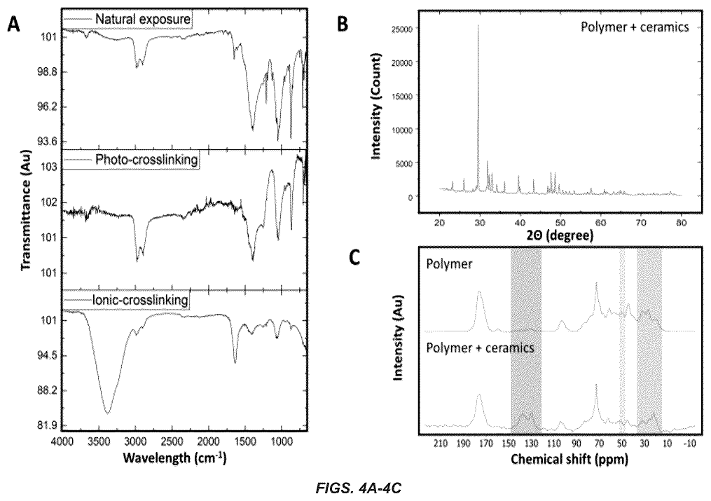

Storage modulus (G′) and loss modulus (G″) were measured for 5 min at 1 rad/s angular frequency, 0.10% strain, and 25° C. (FIG. 6A). The viscoelastic properties of the ink were determined using an oscillatory rheology test. The mechanical stiffness of the non-crosslinked ink was found to be 5.80 kPa, which was assessed from the average of storage modulus (G′) in 5 min measurement (FIG. 6A). The ink with a higher G′ value compared to the loss modulus (G″) usually provides good shape fidelity for the printed construct[18]. The thermal stability of the ink was also investigated using a temperature-dependent rheological test (FIG. 6B). FIG. 6B illustrates temperature sweep test at 1 rad/s and 0.10% strain. The result suggests that the stiffness of the ink can be tuned by increasing the temperature. FIG. 6C illustrates viscosity at different shear rates. The viscosity of the ink during the extrusion was found to be 117 Pa s, which was determined from the calculated shear rate of the nozzle of 8.60 s⁻¹ (FIG. 6C).

The biological assessment results in (FIGS. 7A-7F) show the biocompatibility of the developed ink with biological organisms, like the mesenchymal stem cells (MSC). It was observed that during the initial four days of interaction with the developed ink, an accelerated growth was achieved by the MSC when cultured in the presence of the ink, in comparison to when only being cultured in media. Moreover, after seven days (FIG. 7G), the amount of metabolically active cells was higher in the presence of the ink in comparison to using media. These findings demonstrate the excellent biocompatibility of the developed ink with biological entities and highlight the potential of this ink to be used in tissue engineering applications.

### CONCLUSION

Disclosed embodiments expanded the frontiers of biomaterials commonly used in regenerative medicine to assist in the solution of the latent problem in the marine environmental ecosystem, coral bleaching. Therefore, according to disclosed embodiments, an eco-friendly ink is developed that can potentially be used to restore rigid living systems. Based on a wide range of previous investigations in biomaterials applied for bone and cartilage tissue regeneration, our ink is constituted of biopolymers as gelatin, alginate, gelatin methacrylate (GelMA), and poly (ethylene glycol diacrylate) (PEGDA) with the integration of bioceramics as calcium carbonate and hydroxyapatite, fundamental to mimic structures as corals. Disclosed embodiments demonstrated the effectiveness of the ink to be manufactured by 3D molding and printing technologies, which is a crucial step to develop complex figures that could mimic a coral and serve as a scaffold for biological systems as polyps. Furthermore, disclosed embodiments implemented an image processing and surface analysis to find a more accurate concentration of ceramics imbued in the biopolymers. This innovative analysis provides a new opportunity to mitigate the lack of characterization methods to improve the printability fidelity of novel bioinks. The photo-crosslinking behavior coming from GelMA, PEGDA, and ionic-crosslinking of alginate, make the ink stable for complex physicochemical conditions, as the seawater ecosystem, in which there is an excess of cations, coming from calcium sources. This presents a possibility for in situ appliances in coral reefs with the aid of diverse 3D manufacturing technologies.

Furthermore, the chemical characterization corroborates the interaction of the materials and the crosslinking behavior seen at the infrared spectra peaks for ionic-crosslinking at 3300 cm⁻¹ and photo-crosslinking at 2950-90 cm-1. In addition, the X-Ray diffraction result clearly shows the convergence of calcium carbonate and hydroxyapatite without altering its ground state crystal structure, which corroborates that no other chemical or physical methods are needed under its preparation, making a cost-effective product is easy to produce. Moreover, NMR corroborates the interaction of calcium, phosphate, and carbonate ions from the bioceramics in the biopolymer matrix. Besides, thermochemical characterization with TGA and DSC gives us an initial insight into how the material works with the temperature appliance, which works perfectly for our final scope. Additionally, discussion related to the mechanical properties of the ink, with different tests of rheology to evaluate storage/loss modulus in terms of time and temperature, and its viscosity vs. shear rate, which corroborates the potential printability of the pre-crosslinked ink for manufacturing complex structures. Finally, a biological assessment was done with MSCs, to demonstrate the material's biocompatibility for living MSCs and potentially could be used for different living systems. In conclusion, the material can withstand harsh conditions, and the degradation rate can be controlled with the specific behavior from each constituent of the ink. This formulation is the beginning of future investigations as it has potential use for rigid-living systems with interesting tunable properties that could fulfill different directions regarding the final user's needs.

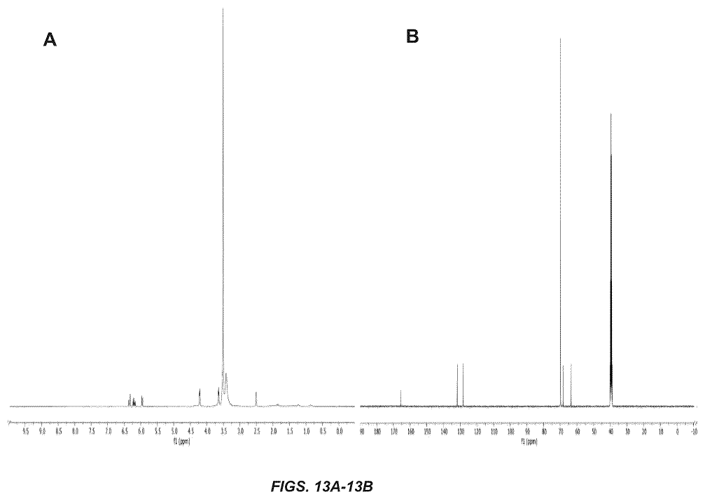

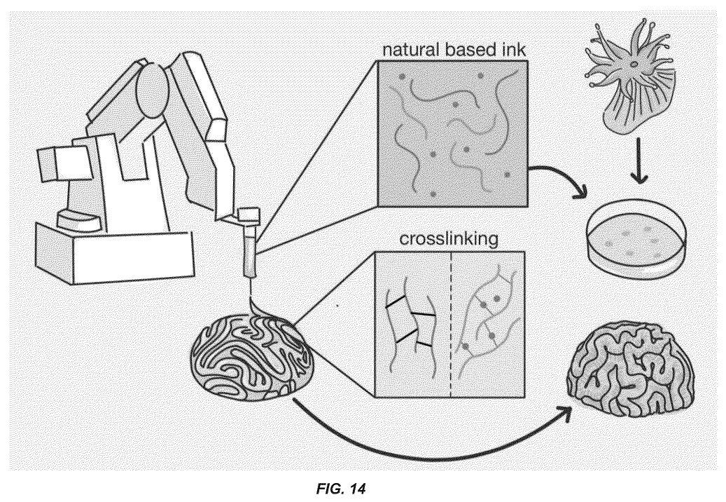

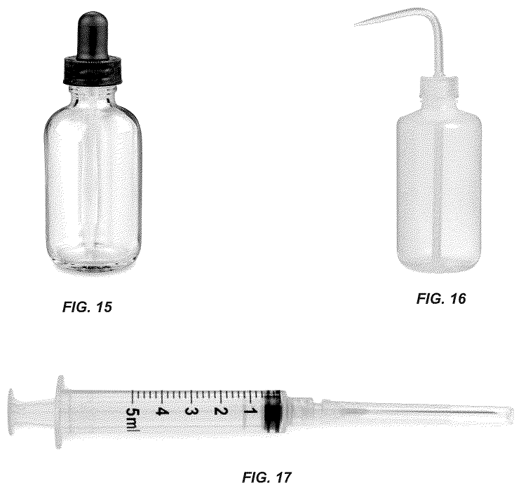

While preferred methods and devices of the present disclosure may include the device selected from the group consisting of a container with a dropper/closure device (FIG. 15), a squeeze bottle device (FIG. 16), and an injectable device (FIG. 17), it is readily appreciated that skilled artisans may employ other means and techniques for delivering the carbonate-based ink.

The injectable device (FIG. 17) may not be limited to syringe-type device. One of ordinary skill in the art would readily appreciate that any injectable device suitable for delivering the carbonate-based ink may be utilized according to aspects of the present disclosure.

One of ordinary skill in the art would readily appreciate that any kind of device suitable for delivering the disclosed products described in the present disclosure may be utilized.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### EXAMPLES

### Example 1

### Materials and Methods

The following materials and reactants are necessary for obtaining the biopolymer base and bioceramics to develop the final paste and subsequently realize the fundamental characterization. The final formulation is homogenized into two main parts. The initial one is the biopolymer base that works as a binder and crosslinking material. The second is the bioceramics side that will reinforce the paste and mimic the paste hard-living structure, a standard coral. Gelatin methacrylate (Synthesized), gelatin from porcine skin (Sigma Aldrich), Alginic acid (Merck), Poly (ethylene glycol diacrylate) (Sigma Aldrich). Lithium phenyl-2,4,6 trimethyl-benzoyl phosphinate (Sigma Aldrich), Milli-Q water, Hydroxyapatite (Sigma Aldrich), Calcium carbonate (Sigma Aldrich), Dimethyl Sulfoxide (Sigma Aldrich), Dialyzer Maxi, MWCO 12-14 kDa (Merck), Bottle Top Vacuum Filter, 0.22 μm (Corning), Dimethyl sulfoxide (DMSO) for NMR (Sigma Aldrich), Phosphate buffered saline, pH 7.4 (Sigma Aldrich), and Syringe pump (Harvard Apparatus).

TABLE 1
Formulation from the complete ink.

| | | Weight | |
|---|---|---|---|
| | | by | |
| | Percentage | cartridge | |
| Biopolymer base | W/W | sample | Purpose |
| High gelatin | 2.50% | 0.25 g. | Photo-crosslinking |
| methacrylate | | | and printability |
| (H-GelMA) | | | |
| Poly (ethylene glycol | 2.50% | 0.25 g.≈0.25 mL. | Increase speed |
| diacrylate) (PEGDA) | | | rate of photo- |
| 700 MW | | | crosslinking |
| Alginic acid (Alg) | 2.50% | 0.25 g. | Ionic crosslinking |
| Low MW | | | with calcium |
| Gelatin (Gel) | 2.50% | 0.25 g. | Viscosity for pre- |
| | | | crosslinked paste |
| Lithium phenyl-2,4,6 | 0.15% | 0.015 g. | Photoinitiation |
| trimethylbenzoyl- | | | 365(UV)-405 |
| phosphinate | | | (blue) nm |
| (LAP) | | | |
| | Percentage | Weight in | |
| Bioceramics | W/W | 10 mL. | Purpose |
| Hydroxyapatite (HA) | 40% | 4 g. | Density for under |
| | | | wet conditions |
| Calcium carbonate | 40% | 4 g. | Mimic coral |
| (CaCO3) | | | chemical Structure |
| Solvent | Quantity | Quantity | Purpose |
| Milli-Q water | 10 mL. | 10 mL. | Dissolve |

### H-GelMA Synthesis

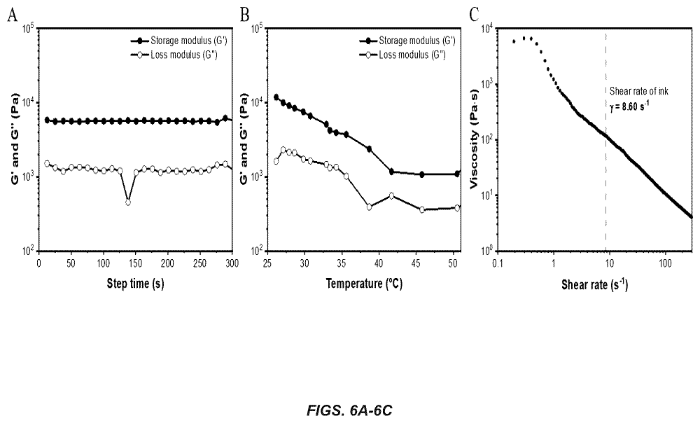

In order to produce a high degree of methacrylation of GelMA (FIGS. 8A-8F), dissolve gelatin in PBS (FIG. 8A), dropwise methacrylation (FIG. 8B), dialysis of the sample (FIG. 8C), filtrations (FIG. 8D), freezing with liquid nitrogen (FIG. 8E), and freeze-drying to get the final product (FIG. 8F). For a high degree of methacrylation of GelMA, 10 g of gelatin, add 100 mL PBS 1× (sterile). Dissolve the mixture with the aid of a heating plate (˜240 rpm at 50° C.). Then 8 mL methacrylic anhydride is added drop-by-drop with the assistance of a syringe pump and let emulsion rotate (240 rpm) at 50° C. for 2 hours. Preheat 100 mL of sterile PBS (50° C.) to dilute GelMA solution for 10 min at 50° C. Prepare the dialysis membrane (MWCO 12-14,000 kDa) at 40° C., insert GelMA solution inside them, and dialyze for a minimum of five days with constant stirring. Change the water from 1 to 2 times a day to eliminate the excess methacrylate ions and dispose of the residue in a regulated container. Use a sterile vacuum (0.22 μm) filtration cup to filter the liquid. Transfer sterilized polymer into Falcon Tubes. Submerge semi-closed tubes in liquid nitrogen and freeze-dried for at least five days to get a sponge-like freeze-dried GelMA sample[12].

### Biopolymer-Base Preparation

Depending on the volume required to prepare and the percentages stated in Table 1, freeze-dried H-GelMA, gelatin, alginate, and PEGDA are dissolved in Milli-Q with constant stirring to dissolve the final solution. Using a heath bath is recommended to melt the solution at a temperature of the maximum of 50° C. A higher temperature can modify the molecular behavior of the four polymer chains and jeopardize the accuracy of printability. Then, the photoinitiator is added (LAP) to the previous solution avoiding the interaction with light. It will trigger the crosslinking reaction; therefore, it is recommended to cover it with aluminum foil. This base can be kept at −20° C. for more extended periods if there is no interaction with light that could trigger gelation.

### Bioceramics Reinforcement

The quantity of bioceramics needed for the formulation is presented in Table 1, imbued at the biopolymer-based solution prepared previously. Solid and constant stirring with a thin spatula is crucial as the final homogenous product will be viscous, like a commercial bone paste. It is recommended to start 3D printing protocols with the fresh material to avoid premature crosslinking with the light or natural desiccation of water. The formulation is intended to be cost-effective because the biopolymer part from the formulation was designed at minimal concentrations without compromising its crosslinking properties and printing fidelity, relying on inexpensive materials for commercial 3D manufacturing technologies.

### Manufacturing

Two methodologies developed 3D manufacturing. The first one was molding, a flexible resin; it is designed in different designs derived from real branched and brain corals obtained in the red sea. The second one is 3D printed derived from the implementation of two systems: a pressure-based bioprinter Inkredible from the Cellink company and the designed 6-degree-of-freedom robotic arm system developed for bioprinting applications at our research group[13].

### Image Processing for 3D Printing

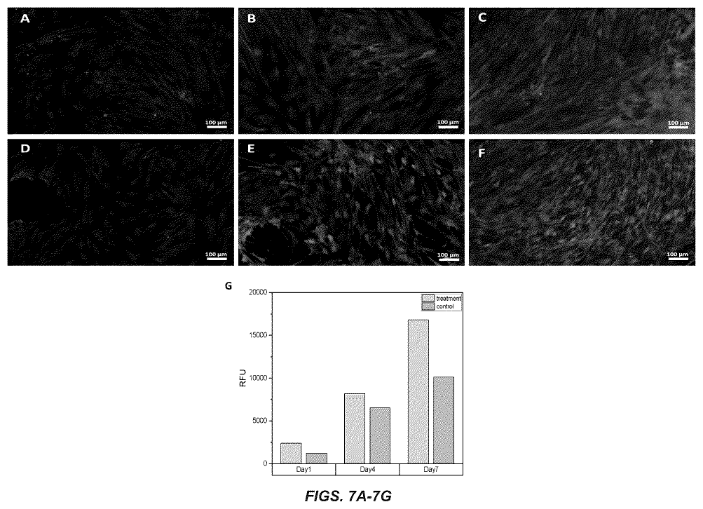

FIG. 9A illustrates schematics from printing the sample, capturing, and processing the pictures in silico, and its analysis. FIG. 9B illustrates an example of how the technique is comparing the similarity of pixels. The similarity structural index measurement (SSIM) is measured by comparing pixels between images; (FIGS. 9A-9B) it can be visually seen how the comparison is made between two fixed figures to get this numerical value [14]. The response surface methodology (RSM) was applied to evaluate the effect of enhancing the developed ink with hydroxyapatite and calcium carbonate over the structural similarity index from the printed structure. According to the statistical modeling reported in recent studies, the elaboration of the RSM was performed with the MATLAB® software, and the model's constants were obtained with the Minitab 18 software (Minitab® LLC, USA). The general model is presented in Equation 1, and the simplified resulting model is shown in Equation 2.

γ=δ₀±δ₁α±δ₂β±δ₃α²±δ₄β²±δ₅(α·β)+εᵢⱼₖ

Equation 1. A general model for the effect of hydroxyapatite and calcium carbonate over the structural similarity index of the printed structure. Where Y is the response and α, β are the factors of the model, δ_{0,1,2,3,4,5} represent the constants of the model, and εᵢⱼₖ is the total error.

$$γ = {δ}_{0} + {δ}_{1} α - {δ}_{2} β - {δ}_{3} {α}^{2} + {δ}_{4} {β}^{2} ; \frac{\partial γ}{\partial i} = {φ}_{i}$$

Equation 2. A simplified model for the effect of hydroxyapatite and calcium carbonate over the structural similarity index of the printed structure. Where Y is the response and α, β are the factors of the model, δ_{0,1,2,3,4} the constants of the model, i represents any of the two factors, and φᵢ the solved values from the partial derivatives.

### Morphological Imaging

The scanning electron microscope FEI Magellan XHR imaging was applied to a grid of the 3D printed formulation, crosslinked, and dried overnight, with an accelerating voltage of 3 kV. The dried samples were sputter-coated with 5 nm Ir before imaging. An optical microscope obtained the macrography with a source of light in the upper side from the sample.

### Chemical Characterization

For Fourier-transform infrared spectroscopy, a Thermo Nicolet iS10 FTIR Spectrometer (Thermofisher) was used; the samples were prepared and crosslinked by two different sources individually compared to control with exposure at room conditions. For Solid-State Nuclear Magnetic Resonance (NMR), the ¹³C Magic Angle Spinning (MAS) NMR spectra were recorded using Bruker Avance 400 MHz spectrometer (Bruker, USA) at room temperature. The sample was lyophilized. Bruker Topspin 3.5pl7 software (Bruker BioSpin, Rheinstetten, Germany) and MestReNova (Mestrelab Research, Spain) were used for data collection and analysis. In addition, Solution-State NMR, the NMR spectra (¹H and ¹³C) of biopolymer-base were recorded using Bruker Avance 400 MHz spectrometer (Bruker, USA) at room temperature. The sample was prepared to dissolve 5 mg powder in 500 μl of d₆-DMSO (Cambridge Isotope Laboratories, USA) and then transferred into 5 mm NMR tubes. Bruker Topspin 3.5pl7 and MestReNova software were used for data collection and processing, respectively of nuclear magnetic resonance (NMR) of H-NMR, C-NMR for the solid and liquid state, the photoinitiator (PI) was not added as it behaves similar to paramagnetic species; therefore, the equipment won't detect any significant signal. A complete sample of a printed coral was ground for X-ray diffraction compared with bioceramics spectra[15, 16]. For Thermochemical characterization, both Thermogravimetric Analysis (TGA) and Differential Scanning Calorimetry (DSC) (TA Instruments), the final printed inks were ground and analyzed by both instruments, around 20 mg of material were used for each sample. The ranges of temperatures used, were 25-850° C. for TGA and 25-400° C. for DSC.

### Viscoelastic Characterization

The mechanical properties of non-crosslinked ink were analyzed using TA Ares-G2 Rheometer equipped with Advanced Peltier System (APS). A freshly prepared ink was measured using an 8 mm parallel plate with a 1.8 mm gap at 25° C. The stiffness was analyzed through a time-sweep test for 5 minutes with angular frequency and one rad/s and 0.1% strain, respectively. A temperature sweep was subsequently performed on the sample by applying a gradual temperature increase from 25° C. to 50° C. with similar angular frequency and strain.

The viscosity of the ink before crosslinking was determined using 25 mm parallel plate geometry with a 0.5 mm gap at 25° C. Three replicate samples were measured using a 25 mm parallel plate geometry with a gap of 0.5 mm at 25° C. The flow experiment was set up by starting the shear rate from 0.001 to 300 s⁻¹ for a 600-seconds duration. According to one disclosed embodiment, the value of the shear rate chosen for the disclosed printing system was calculated using the equation below[17, 18]:

$$γ = \frac{8 Q}{π {d}^{3}}$$

Equation 3. γ: shear rate (s⁻¹); Q: flow rate (2 μL/s); d: diameter of needle (0.84 mm).

### Biological Assessments

Undifferentiated MSCs were seeded at a density of 15.5E3 cells/cm² and incubated for seven days (5% CO₂, 37° C.) in supplemented DMEM-F12 medium. The media was changed on the fourth day. Then, the treated cells were cultivated together with a droplet of 10 μL of crosslinked bioink. As a blank, a droplet was incubated in the same conditions, with no cells. As a control, cells were cultured without a droplet of bioink. The cells proliferation was measured using Alamar Blue (Invitrogen, CAT: DAL1025) by added 1/10^{th} of the volume directly to the cells, followed by 2 hours of incubation. Fluorescence was read in a PheraStar plate reader (Ex/Em: 485/520). The cell viability was evaluated using the Live/Dead assay (Invitrogen, CAT: L3224).

### REFERENCES

The following references are referred to above and are incorporated herein by reference:
1. Chesterman J, Zhang Z, Ortiz O, et al., “Biodegradable Polymers,” In: Principles of Tissue Engineering. 5th ed., Ch. 18. Academic Press, 317-342 (2020).
2. Biswal T, BadJena S K, Pradhan D, “Sustainable Biomaterials and their Applications: A Short Review,” Mater Today 30, 274-82 (2020).
3. Simionescu B C, Ivanov D, “Natural and Synthetic Polymers for Designing Composite Materials,” In: Handbook of Bioceramics and Biocomposites. Ch. 11-1. Wiley-VCH: Weinheim, 1-54 (2015).
4. Lee M, Rizzo R, Surman F, Zenobi-Wong M, “Guiding Lights: Tissue Bioprinting Using Photoactivated Materials,” Chem Rev 120, 10950-1027 (2020).
5. Chimene D, Miller L, Cross L M, et al., “Nanoengineered Osteoinductive Bioink for 3D Bioprinting Bone Tissue,” ACS Appl Mater Interfaces 12, 15976-88 (2020).
6. Zhou H, Lee J, “Nanoscale Hydroxyapatite Particles for Bone Tissue Engineering,” Acta Biomater 7, 2769-81 (2011).
7. Kelly B E, Bhattacharya I, Heidari H, et al, “Volumetric Additive Manufacturing Via Tomographic Reconstruction,” Science 363, 1075-9 (2019).
8. Leggat W P, Camp E F, Suggett D J, et al., “Rapid Coral Decay is Associated with Marine Heatwave Mortality Events on Reefs,” Curr Biol 29, 2723-30.e4 (2019).
9. Mass T, et al., “Amorphous Calcium Carbonate Particles form Coral Skeletons,” Proc Natl Acad Sci 114, E7670-8 (2017).
10. Wangpraseurt D, You S, Azam F, et al., “Bionic 3D Printed Corals,” Nat Commun 11, 1748 (2020).
11. Yu A C, Reinhart M, Hunter R, et al., “Seasonal Impact of Phosphate-Based Fire Retardants on Soil Chemistry Following the Prophylactic Treatment of Vegetation,” Environ Sci Technol 55, 2316-23 (2021).
12. Loessner D, Meinert C, Kaemmerer E, et al., “Functionalization, Preparation and use of Cell-laden Gelatin Methacryloyl-based Hydrogels as Modular Tissue Culture Platforms,” Nat Protoc 11, 727-46.
13. Khan Z, Kahin K, Rauf S, et al., “Optimization of a 3D Bioprinting Process Using Ultrashort Peptide Bioinks,” Int J Bioprint 5, 173 (2019).
14. Gong J, Schuurmans C C, van Genderen A M, et al., “Complexation-induced Resolution Enhancement of 3D-Printed Hydrogel Constructs,” Nat Commun 11, 1267 (2020).
15. Gonzalez-Rios J A, Valle-Pérez A U, Amaya-Delgado L, et al., “A Quick Fed-batch Saccharification Strategy of Wheat Straw at High Solid Loadings Improving Lignocellulosic Ethanol Productivity,” Biomass Conversion Biorefinery 13, 4991-5003 (2021).
16. Valle-Pérez A U, Flores-Cosio G, Amaya-Delgado L, “Bioconversion of Agave Bagasse to Produce Cellulases and Xylanases by Pencillium citrinum and Aspergillus fumigatus in Solid-State Fermentation,” Waste Biomass Valorization 12, 5885-5897 (2021).
17. Susapto H H, Alhattab D, Abdelrahman S, et al., “Ultrashort Peptide Bioinks Support Automated Printing of Large-Scale Constructs Assuring Long-Term Survival of Printed Tissue Constructs,” Nano Lett 21, 2719-29 (2021).
18. Theus A S, Ning L, Hwang B, et al., “Bioprintability: Physiomechanical and Biological Requirements of Materials for 3D Bioprinting Processes,” Polymers 12, 2262 (2020).
19. Doostmohammadi A, Monshi A, Salehi R, et al., “Cytotoxicity Evaluation of 63s Bioactive Glass and Bone-Derived Hydroxyapatite Particles Using Human Bone-marrow Stem Cells,” Biomed Pap Med Fac Univ Palacky Olomouc Czech Repub, 155, 323-6 (2011).
20. Parvez S, Rahman M M, Khan M A, et al., “Preparation and Characterization of Artificial Skin Using Chitosan and Gelatin Composites for Potential Biomedical Application,” Polym. Bull 69, 715-31 (2012).
21. Guo X, Liu L, Wang W, et al., “Controlled Crystallization of Hierarchical and Porous Calcium Carbonate Crystals Using Polypeptide Type Block Copolymer as Crystal Growth Modifier in a Mixed Solution,” Cryst Eng Commun 13, 2054-2061 (2011).
22. Saarai A, Kasparkova V, Sedlacek T, et al., “On the Development and Characterisation of Crosslinked Sodium Alginate/Gelatine Hydrogels,” J Mech Behav Biomed Mater 18, 152-66 (2013).
23. Aldana A A, Malatto L, Rehman M A, et al., “Fabrication of Gelatin Methacrylate (GelMA) Scaffolds with Nano- and Micro-Topographical and Morphological Features,” Nanomaterials 9, 120 (2019).
24. Kontoyannis C G, Vagenas N V, “Calcium Carbonate Phase Analysis Using XRD and FT-Raman Spectroscopy,” Analyst 125, 251-5 (2000).
25. Manafi S A, Yazdani B, Rahimiopour M R, et al., “Synthesis of Nano-hydroxyapatite under a Sonochemical/Hydrothermal Condition,” Biomed Mater 3, 025002 (2008).
26. Duan P, Li X, Wang T, et al., “The Chemical Structure of Carbon Nanothreads Analyzed by Advanced Solid-State NMR,” J Am Chem Soc 140, 7658-66 (2018).
27. Zhu M, Wang Y, Ferracci G, et al., “Gelatin Methacryloyl and its Hydrogels with an Exceptional Degree of Controllability and Batch-to-Batch Consistency,” Sci Rep 9, 6863 (2019).
28. Raveendran N T, Vaquette C, Meinert C, et al., “Optimization of 3D Bioprinting of Periodontal Ligament Cells,” Dent Mater 35, 1683-94 (2019).
29. Tan F, Xu X, Deng T, e al., “Fabrication of Positively Charged Poly(Ethylene Glycol)-Diacrylate Hydrogel as a Bone Tissue Engineering Scaffold,” Biomed. Mater, 7, 055009 (2012).
30. Gill P, Moghadam T T, Ranjbar B, “Differential Scanning Calorimetry Techniques: Applications in Biology and Nanoscience,” J. Biomol. Technol. 21, 167-193 (2010).

All documents, patents, journal articles and other materials cited in the present application are incorporated herein by reference.

While the present disclosure has been disclosed with references to certain embodiments, numerous modification, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

What is claimed is:

1. A carbonate-based ink comprising:
a biopolymer-based mixture; and
a bioceramics,
wherein the biopolymer-based mixture comprises a gelatin and a polysaccharide,
wherein the bioceramics comprises an apatite,
wherein the biopolymer-based mixture is mixed with the bioceramics to form the ink,
wherein the ink is capable of being applied under wet or dry condition.

2. The carbonate-based ink of claim 1, wherein the wet condition is seawater or water or other aqueous solution.

3. The carbonate-based ink of claim 1, wherein the biopolymer-based mixture further comprises a high gelatin methacrylate, a photoinitiator, and a polyether and wherein the bioceramics further comprises a carbonate.

4. A carbonate-based ink comprising:
a high gelatin methacrylate;
a gelatin;
a photoinitiator;
a polysaccharide;
a polyether;
an apatite;
a carbonate; and
a solvent,
wherein the high gelatin methacrylate, the gelatin, the photoinitiator, the polysaccharide, and the polyether are dissolved in the solvent to form a first mixture,
wherein the apatite and the carbonate are mixed with the first mixture to form the ink,
wherein the ink is capable of being applied under wet or dry conditions.

5. The carbonate-based ink of claim 4, wherein the wet condition is seawater or water or other aqueous solution.

6. The carbonate-based ink of claim 4, wherein the photoinitiator is a lithium phenyl-2,4,6, trimethylbenzoylphosphinate (LAP).

7. The carbonate-based ink of claim 4, wherein the apatite is a hydroxyapatite.

8. The carbonate-based ink of claim 4, wherein the polysaccharide is an alginic acid.

9. The carbonate-based ink of claim 4, wherein the polyether is a poly (ethylene glycol diacrylate).

10. The carbonate-based ink of claim 4, wherein the solvent is at least one selected from the group consisting of dimethyl sulfoxide (DMSO), phosphate-buffered saline (PBS), and seawater or water or other aqueous solution.

11. The carbonate-based ink of claim 4, wherein the carbonate is a calcium carbonate.

12. A method of manufacturing a carbonate-based ink comprising:
mixing a bioceramics with a biopolymer-based mixture to form the carbonate-based ink,
wherein the bioceramics comprises an apatite and a carbonate,
wherein the biopolymer-based mixture comprises a solvent, a high gelatin methacrylate, a gelatin, a photoinitiator, a polysaccharide, and a polyether,
wherein the ink is applied under wet or dry conditions.

13. The method of claim 12, wherein the wet condition is seawater or water or other aqueous solution.

14. The method of claim 12, wherein the apatite is a hydroxyapatite and wherein the carbonate is a calcium carbonate.

15. The method of claim 12, wherein the photoinitiator is a lithium phenyl-2,4,6, trimethylbenzoylphosphinate (LAP), wherein the polysaccharide is an alginic acid, and wherein the polyether is a poly (ethylene glycol diacrylate).

16. The method of making the biopolymer-based mixture of claim 12 comprising:
mixing a high gelatin metacrylate, a gelatin, a polysaccharide, and a polyether in a solvent at an average temperature in a range of approximately 20 to 50° C. to form a first mixture; and
adding a photoinitiator to the first mixture while avoiding an interaction with UV light or visible light to produce the biopolymer-based mixture.

17. The method of claim 16, wherein the polysaccharide is an alginic acid.

18. The method of claim 16, wherein the photoinitiator is a lithium phenyl-2,4,6, trimethylbenzoylphosphinate (LAP), wherein the polyether is a poly (ethylene glycol diacrylate), and wherein the solvent is water.

19. A method of applying a carbonate-based ink comprising:
2D-3D printing or 2D-3D molding with the carbonate-based ink of claim 4.

20. A kit comprising an effective amount of the carbonate-based ink of claim 4, wherein the carbonate-based ink is applied in at least one selected from the group consisting of 2D-3D printing and 2D-3D molding.

21. A device for applying a carbonate-based ink, wherein the device comprises an effective amount of the carbonate-based ink of claim 4 and wherein the carbonate-based ink is applied in at least one selected from the group consisting of 2D-3D printing and 2D-3D molding.

22. The device of claim 21, wherein the 3D printing is an extrusion-based 3D printing.

23. The device of claim 21, wherein the device is selected from the group consisting of a container with a dropper/closure device, a squeeze bottle device, and an injectable device.
